(19) United States
(12) Patent Application Publication
(10) Pub. No.: US 2026/0230265 A1
(43) Pub. Date: Aug. 6, 2026

(54) RESOURCE AND REPORT CONFIGURATION ENHANCEMENTS FOR TYPE 2 NETWORK SPATIAL ELEMENTS ADAPTATION

(71) Applicant: APPLE INC., Cupertino, CA (US)

(72) Inventors: Dan Wu, Beijing (CN); Haitong Sun, Cupertino, CA (US); Dawei Zhang, San Diego, CA (US); Wei Zeng, San Diego, CA (US); Sigen Ye, San Diego, CA (US); Chunhai Yao, Beijing (CN); Seyed Ali Akbar Fakoorian, San Diego, CA (US)

(21) Appl. No.: 19/152,238

(22) PCT Filed: Feb. 16, 2023
(86) PCT No.: PCT/CN2023/076570

§ 371 Date: Jul. 30, 2025

(51) Int. Cl. H04L 5/00; H04W 24/10

(52) U.S. Cl. CPC H04L 5/0051; H04W 24/10

(57) ABSTRACT

A wireless communication system may use resource and report configuration enhancements for Type 2 network spatial elements adaptation. In some embodiments, the network node may configure a first CSI resource setting and at least a second CSI resource setting for channel measurement. The first CSI resource setting and the second CSI resource setting link to one CSI reporting setting. The second CSI resource setting may comprise different spatial relation information or a different antenna port than the first resource setting.

### TECHNICAL FIELD

This application relates generally to wireless communication systems, including CSI-RS resource configurations to support spatial adaptation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates type 1 TxRU reduction in accordance with some embodiments.

FIG. 1B illustrates type 2 TxRU reduction in accordance with some embodiments.

FIG. 2 illustrates a portion of a CSI-ReportConfig information element in accordance with some embodiments.

FIG. 3 illustrates a CSI-ResourceConfig information element in accordance with some embodiments.

FIG. 4 illustrates a CSI-RS resource set information element and a CSI-RS information element in accordance with some embodiments.

FIG. 5 illustrates a CSI-AperiodicTriggerStateList information element in accordance with some embodiments.

FIG. 6 illustrates potential new elements that may be introduced to support multi-CSI report for spatial elements adaptation in accordance with some embodiments.

FIG. 7 illustrates a CSI-RS resource set information element with additional CSI-RS resources for spatial elements adaptation measurement in accordance with some embodiments

FIG. 8 illustrates a MAC CE for activation of one or both of the spatial adaptation CSI-RS resources and the original CSI-RS resources in accordance with some embodiments.

FIG. 9 illustrates a first transmission timeline in accordance with some embodiments.

FIG. 10 illustrates a second transmission timeline in accordance with some embodiments.

FIG. 11 illustrates a third transmission timeline in accordance with some embodiments.

FIG. 12 illustrates a fourth transmission timeline in accordance with some embodiments.

FIG. 13 illustrates a fifth transmission timeline in accordance with some embodiments.

FIG. 14 illustrates a sixth transmission timeline in accordance with some embodiments.

FIG. 15 illustrates a seventh transmission timeline in accordance with some embodiments.

FIG. 16 illustrates a CSI-ResourceConfig information element with both the original resource set and an additional resource set for spatial adaptation in accordance with some embodiments.

FIG. 17 illustrates a CSI-ReportConfig information element comprising original CSI-ResourceConfig information element and spatial adaptation CSI-ResourceConfig information element in accordance with some embodiments.

FIG. 18 illustrates a flowchart of a method of a network node in accordance with some embodiments.

FIG. 19 illustrates a flowchart of a method of a UE in accordance with some embodiments.

FIG. 20 illustrates a flowchart of a method of a network node in accordance with some embodiments.

FIG. 21 illustrates a flowchart of a method of a UE in accordance with some embodiments.

FIG. 22 illustrates an example architecture of a wireless communication system, according to embodiments disclosed herein.

FIG. 23 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One of the goals in wireless communication networks is energy reduction. Energy use may be reduced on both the UE side and the network node side. One objective for Release-18 of the 3rd Generation Partnership Project (3GPP) is network energy savings.

To save energy, a network node may use spatial element adaptation. For example, the network node may disable spatial elements associated with logical antenna ports. However, there is a need to specify certain techniques in spatial and power domains to enable spatial element adaptation. Some embodiments herein specify enhancements on channel state information (CSI) and beam management related procedures (e.g., measurement, reporting, and signaling) to enable efficient adaptation of spatial elements (e.g. antenna ports, active transceiver chains).

Spatial element adaptation may be referred to as transceiver unit (TxRU) reduction because it may limit the number of TxRUs that the network node uses. TxRU reduction may be categorized into two types. A network node may control spatial elements at a port level or at the receiver unit level.

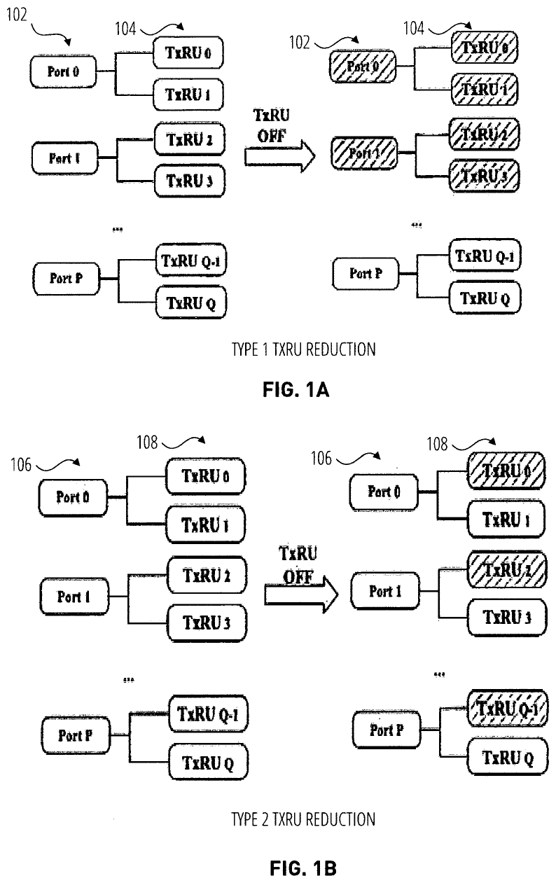

FIG. 1A illustrates type 1 TxRU reduction. Type 1 TxRU reduction allows a network node to enable/disable all spatial elements (e.g., TxRUs 104) associated to a logical antenna port (e.g., ports 102). The network node may enable and/or disable a subset of ports of a CSI-RS resource.

In the illustrated example, the network node disables Port 0 and Port 1 and enables Port P. By disabling Port 0 and Port 1, the network node disables all the elements associated with Port 0 and Port 1 which includes TxRU 0, TxRU 1, TxRU 2, TxRU 3. A UE would then measure the CSI-Reference Signal (RS) from the subset of enabled ports.

FIG. 1B illustrates type 2 TxRU reduction. Type 2 TxRU reduction allows a network node to enable/disable part of the spatial elements (e.g., TxRUs 108) associated to a logical antenna port (e.g., ports 106). This may result in changes to the antenna pattern, gains, TCI states, and/or transmission power of the reference signal or channel that uses the antenna port(s).

A UE may measure the CSI-Reference Signal (RS). The measurements may be different if all TxRU than if some of the TxRUs are disabled because of the change in the spatial filter. The TxRU reduction for CSI-RS allows for accurate measurements that may be used by the network node for future transmissions using a reduced number of ports or TxRUs.

As these types of TxRU reductions may result in a different CSI, it may be desirable to support multiple CSI reports. A multi-CSI report may include additional CSI report(s) reflecting the effect of spatial elements adaptation. Some embodiments herein provide details of the resource configurations and related report configurations to support multi-CSI report for the above Type 1 spatial elements adaptation shown in FIG. 1A.

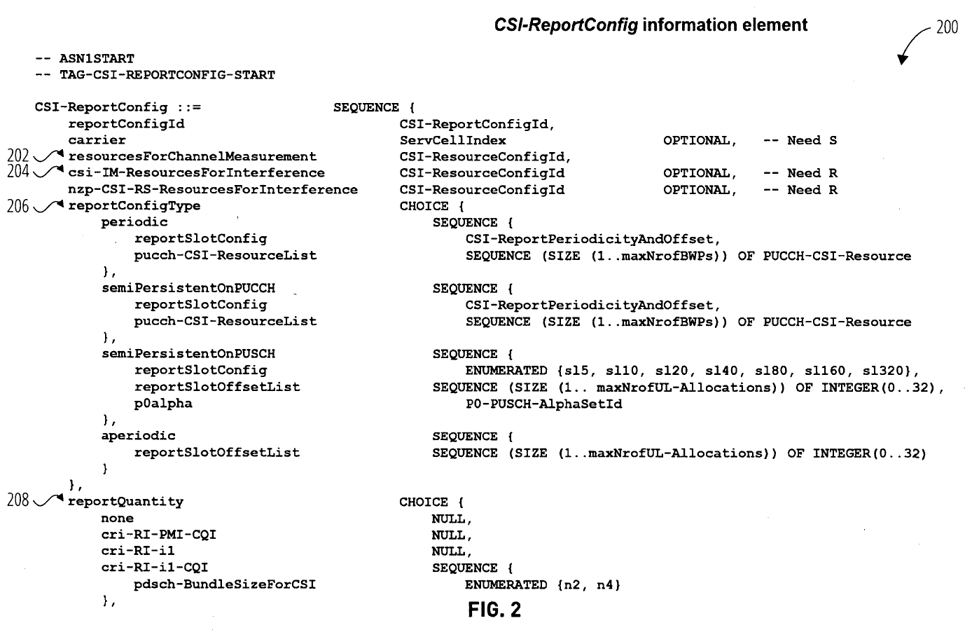

FIG. 2 illustrates a portion of a CSI-ReportConfig information element 200 in accordance with some embodiments. The network's downlink depends on feedback from a UE. Based on the feedback, the network node makes a scheduling decision. The feedback from the UE includes a CSI report. A network node may send the CSI-ReportConfig information element 200 to a UE to configure the CSI report.

The CSI-ReportConfig information element 200 includes information for configuring a CSI report. For example, the illustrated CSI-ReportConfig information element 200 configures resources for channel measurements and for interference measurements (e.g., resourcesForChannelMeasurement field 202, csi-IM-ResourcesForInterference field 204). The CSI-ReportConfig information element 200 may also include type fields 206 that configure the report type (e.g., periodic, semipersistent, or aperiodic).

The CSI-ReportConfig information element 200 may also configure what the UE is to report in a reportQuantity field 208. For example, the UE may be configured to report channel quality information (CQI), precoding matrix indicators (PMI), and rank indicator (RI). Additional configuration elements may be included in the CSI-ReportConfig information element 200.

The resourcesForChannelMeasurement field 202 includes a CSI-ResourceConfigId that associates the CSI-ReportConfig information element with a CSI-ResourceConfig information element. The CSI-ResourceConfig information element may define a group of one or more NZP-CSI-RS-ResourceSet, CSI-IM-ResourceSet and/or CSI-SSB-ResourceSet.

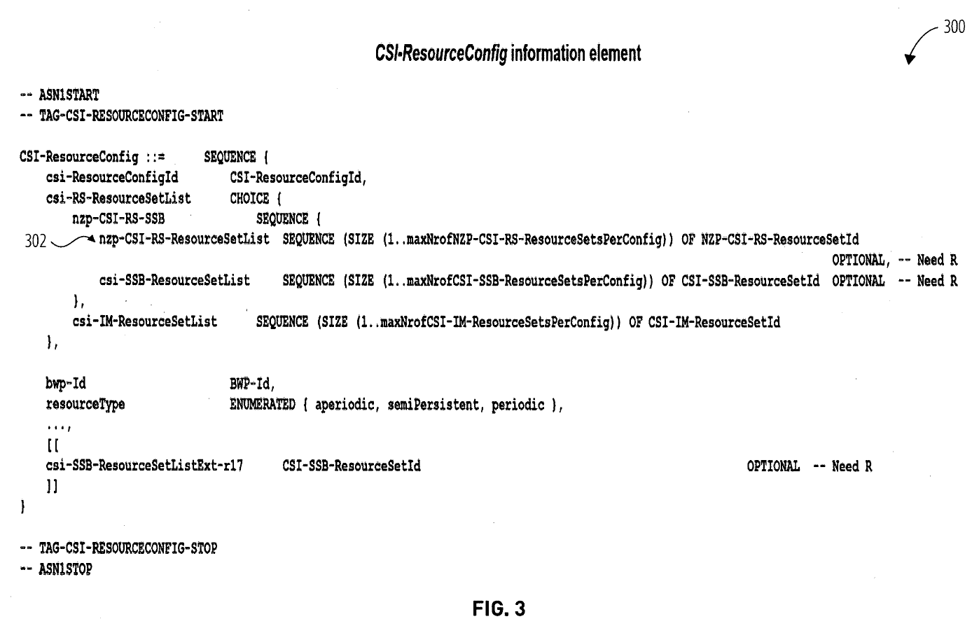

FIG. 3 illustrates a CSI-ResourceConfig information element 300 in accordance with some embodiments. The CSI-ResourceConfig information element 300 may include an nzp-CSI-RS-ResourceSetList field 302. The nzp-CSI-RS-ResourceSetList field 302 may be used to provide a list of references to NZP CSI-RS resources used for beam measurement and reporting in a CSI-RS resource set.

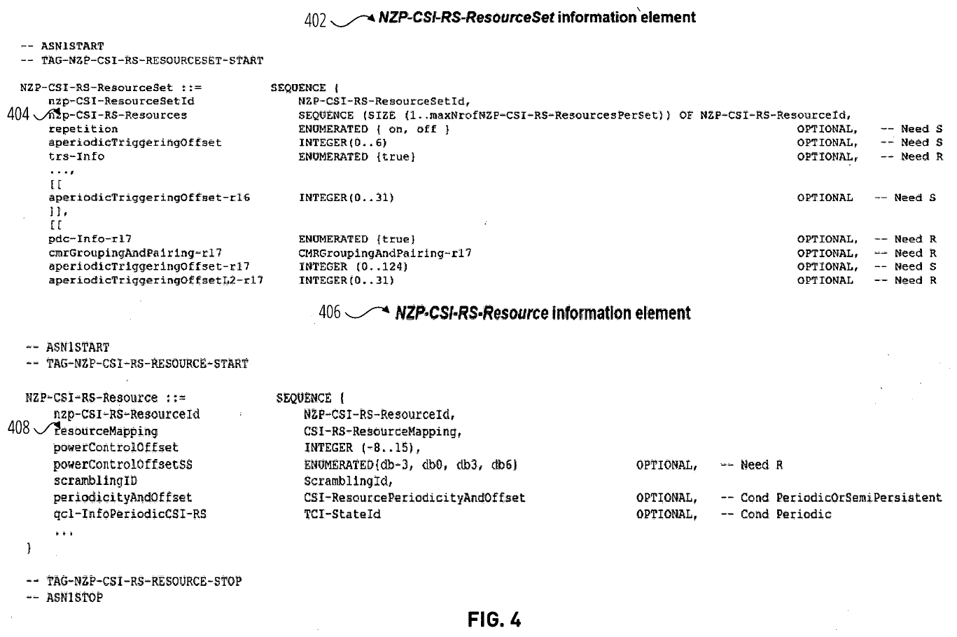

FIG. 4 illustrates a CSI-RS resource set information element 402 and a CSI-RS information element 406. The CSI-RS resource set information element 402 may include multiple resources. The nzp-CSI-RS-Resources field 404 may include the resources associated with this NZP-CSI-RS resource set.

The resources may be configured with the CSI-RS information element 406. The CSI-RS-Resource information element 406 may include a resourceMapping field 408. The resourceMapping field 408 may provide orthogonal frequency-division multiplexing (OFDM) symbol location(s) in a slot and subcarrier occupancy in a Physical Resource Block (PRB) of the CSI-RS resource.

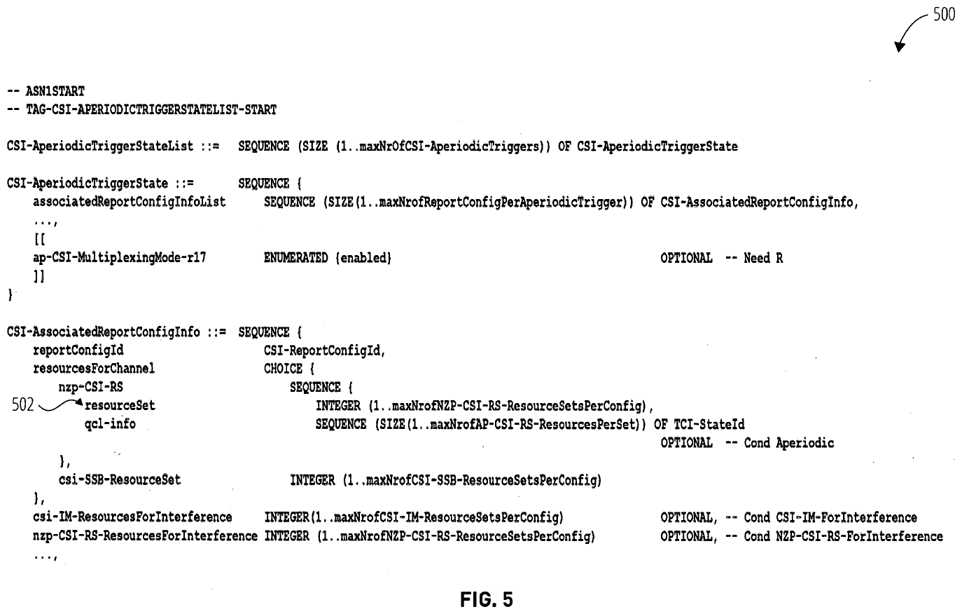

FIG. 5 illustrates a CSI-AperiodicTriggerStateList information element 500 in accordance with some embodiments. The CSI-AperiodicTriggerStateList information element 500 may be used to configure the UE with a list of aperiodic trigger states. Each codepoint of the DCI field “CSI request” may be associated with one trigger state. Upon reception of the value associated with a trigger state, the UE may perform measurement of CSI-RS and aperiodic reporting on L1 according to all entries in the associatedReportConfigInfoList for that trigger state. The resource set field 502 includes a NZP-CSI-RS-ResourceSet for channel measurements.

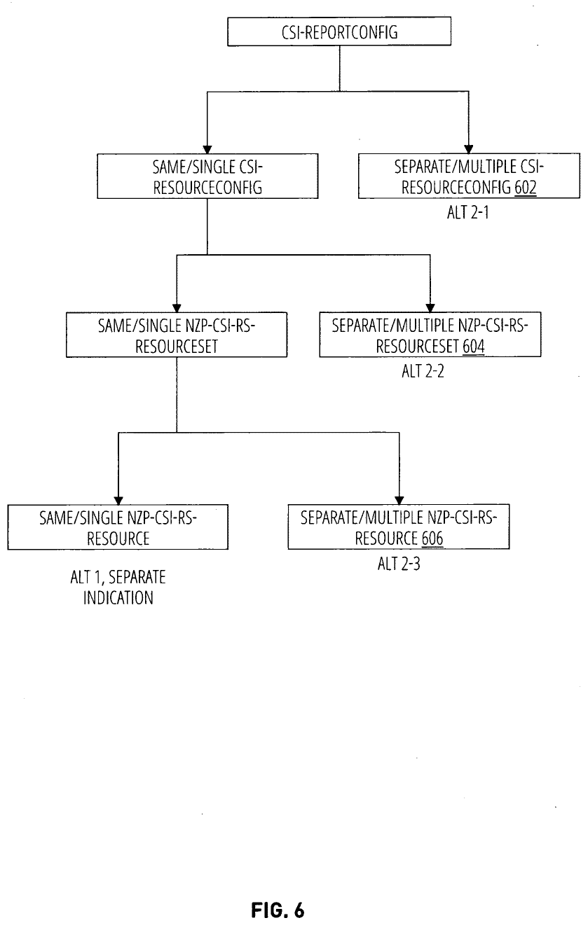

In some embodiments, one or more of the CSI-ReportConfig information element 200, the CSI-ResourceConfig information element 300, the CSI-RS resource set information element 402, and the CSI-RS-Resource information element 406 may be modified to support multi-CSI report for spatial elements adaptation. FIG. 6 illustrates potential new elements that may be introduced to support multi-CSI report for spatial elements adaptation.

To support the multi-CSI report on spatial elements, the network node may provide additional information on the CSI-RS resource(s) for UE to measure. In some embodiments, new resource(s) setting configurations may not be needed. These embodiments may be used to support Type 1 TxRU reduction, where UE could measure on the original CSI-RS resource but with a different assumption on ports. A new indication on a number of ports and subset of ports to be measured may be introduced.

In some embodiments, the CSI-ReportConfig information element, the CSI-ResourceConfig information element, the CSI resource set information element, and the CSI-RS-Resource information element may be reused by using a separate indication.

In some embodiments, new resource(s) may be used for Type 2 TxRU reduction. These new resource(s) may be used due to the change of beam patterns caused by Type 2 TxRU reduction. Accordingly, some embodiments may use a separate CSI-resourceConfig or multiple CSI-resourceConfigs 602 (e.g., ALT 2-1), a separate NZP-CSI-RS-resourceSet or multiple NZP-CSI-RS-resourceSets 604 (e.g., ALT 2-2), or a separate NZP-CSI-RS-Resource or multiple NZP-CSI-RS-Resources to support the multi-CSI report 606 (e.g., ALT 2-3).

Embodiments herein refer to using a separate or multiple CSI-resourceConfigs, NZP-CSI-RS-resourceSets, or multiple NZP-CSI-RS-Resources to support one or multiple CSI-RS resource(s) for spatial elements adaptation measurement. The embodiments herein refer to the different as original CSI-RS resources and additional CSI-RS resources for illustration. However, the disclosed embodiments may be used with different combinations of resources in addition to the original CSI-RS resources and additional CSI-RS resources described. The embodiments herein are provided to support multiple CSI-RS resource(s).

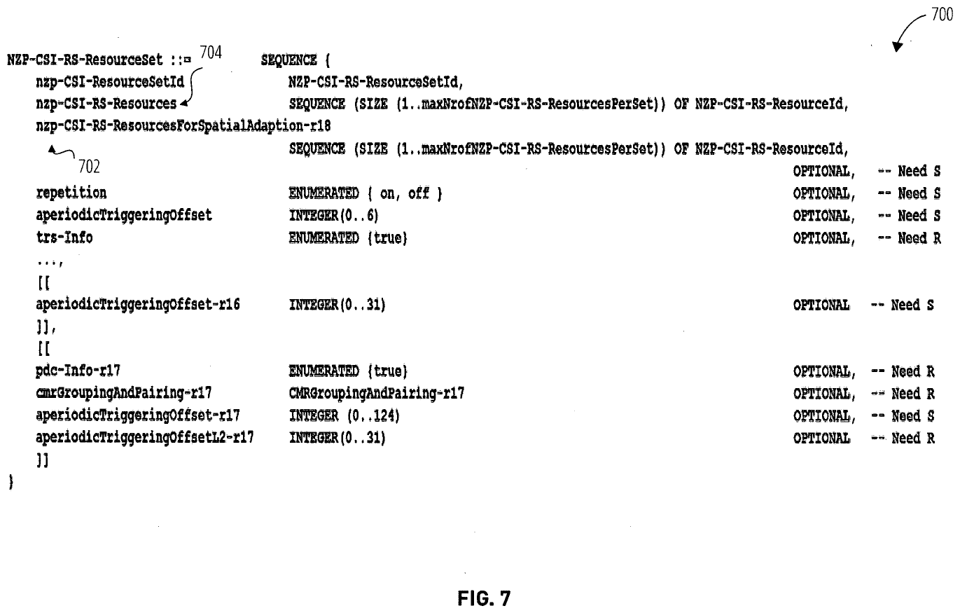

FIG. 7 illustrates a CSI-RS resource set information element 700 with additional CSI-RS resources for spatial elements adaptation measurement (i.e., spatial adaptation CSI-RS resources 702). In some embodiments, the network node may indicate separate resource(s) within one CSI-RS resource set. This may allow the network node to explicitly configure one or multiple CSI-RS resource(s) for spatial elements adaptation measurement in a single CSI-RS resource set (which is the same CSI-RS resource set as the original CSI-RS resources 704). The original CSI-RS resources 704 correspond to the network node using all of the logical antenna ports with all of the spatial elements enabled.

In some embodiments, the spatial adaptation CSI-RS resources 702 may have a different spatial mapping than the original CSI-RS resources 704. In some embodiments, the number of CSI-RS resources in the spatial adaptation CSI-RS resources 702 may be reduced in comparison to the original CSI-RS resources 704. The reduced CSI-RS resources may reflect the change of the number of beams for beam management due to the change of beam width when fewer TxRUs per antenna port are used. For example, the beam width may become wider for an antenna port when some of the TxRUs associated with the antenna port are disabled and beam sweeping may be accomplished using fewer of the wider beams.

The CSI-RS resources configured in new resources for a spatial adaptation information element may have different resource IDs than those configured in the original resources information element. For example, the NZP-CSI-RS-ResourceId of the spatial adaptation CSI-RS resources 702 may be different from the original CSI-RS resources 704. The spatial adaptation CSI-RS resources 702 and original CSI-RS resources 704 can be activated or triggered in Medium Access Control (MAC) control element (CE) or downlink control information (DCI).

Using one CSI-RS resource set to indicate separate CSI-RS resources may have some advantages. For instance, embodiments using such a configuration may use most other configurations within a resource set for the separate CSI-RS resources without introducing additional redundant configurations. Therefore, these embodiments can have a low configuration overhead.

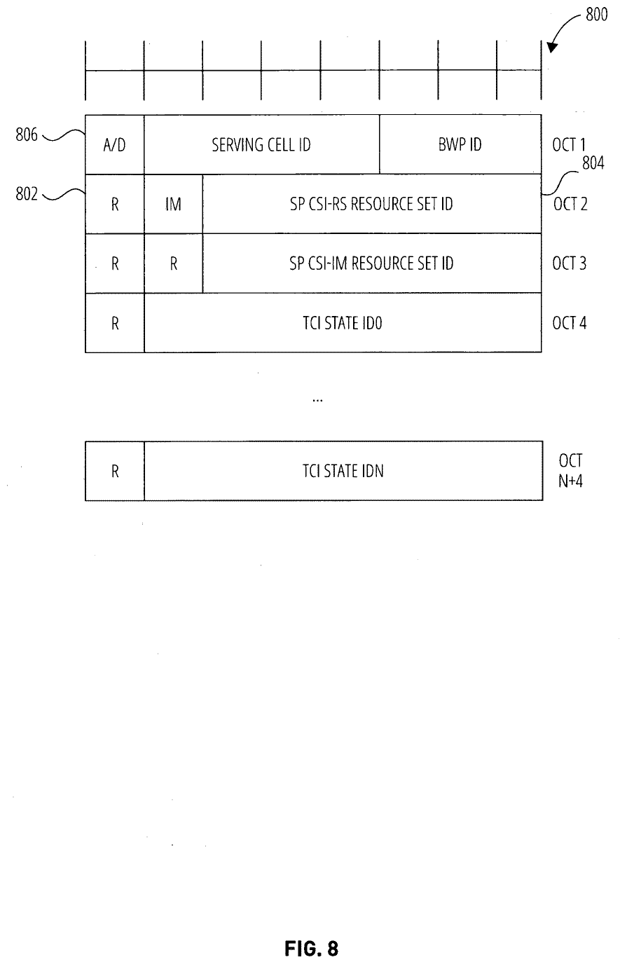

FIG. 8 illustrates a MAC CE 800 for activation of one or both of the spatial adaptation CSI-RS resources and the original CSI-RS resources in accordance with some embodiments. For a CSI resource setting configured as semi-persistent, the resources in a resource set may be indicated as activated/deactivated in one MAC CE 800. The network may activate and deactivate the configured Semi-persistent CSI-RS resource sets of a Serving Cell by sending the SP CSI-RS Resource Set Activation/Deactivation MAC CE 800. The configured Semi-persistent CSI-RS resource sets may be initially deactivated upon configuration and after a handover.

The Activation/Deactivation field 806 indicates whether to activate or deactivate indicated a SP CSI-RS resource set. The Activation/Deactivation field 806 may be set to 1 to indicate activation, otherwise it indicates deactivation. The MAC CE 800 may be called an activation MAC CE if the Activation/Deactivation field 806 is set to 1, and may be called a deactivation MAC CE if the Activation/Deactivation field 806 is set to 0.

The MAC CE 800 may include a SP CSI-RS resource set ID field 804. The SP CSI-RS resource set ID field 804 may contain an index of a NZP-CSI-RS-ResourceSet containing Semi Persistent NZP CSI-RS resources, thereby indicating the Semi Persistent NZP CSI-RS resource set which shall be activated or deactivated. However, as described with reference to FIG. 7, some embodiments may use a single CSI-RS-Resource Set that contains both the spatial adaptation CSI-RS resources and the original CSI-RS resources. Accordingly, simply listing the CSI-RS-Resource Set may cause both the spatial adaptation CSI-RS resources and the original CSI-RS resources to be activated.

Activating both of the spatial adaptation CSI-RS resources and the original CSI-RS resources may be undesirable in certain instances. For example, some network nodes may not be able to support the complexity of operating both the spatial adaptation CSI-RS resources and the original CSI-RS resources simultaneously. Further, network nodes may not always desire to operate in a power savings mode, and during those instances, the spatial adaptation CSI-RS resources do not need to be used.

In some embodiments, the reserved bit 802 in the MAC CE can be used to indicate whether the spatial adaptation CSI-RS resources or the original CSI-RS resources. For example, the network node may set the reserved bit 802 to 1 to indicate whether the additional resources nzp-CSI-RS-ResourcesForSpatialAdaption-r18 are activated/deactivated. Further, when the network node sets the reserved bit to 0, the original resources may be activated/deactivated. Considering the network node's ability on how frequently it can change its TxRU-to-antenna mapping, the following options for activation/deactivation of the CSI-RS can be considered.

In some embodiments, the additional CSI-RS resources (e.g., the spatial adaptation CSI-RS resources) and the original CSI-RS resources cannot be simultaneously activated due to a network node constraint. In these embodiments, an activation MAC CE with the reserved bit 802 equal to 1 may activate the resources configured in nzp-CSI-RS-ResourcesForSpatialAdaption-r18 (i.e., the spatial adaptation CSI-RS resources). If the resources configured in nzp-CSI-RS-Resources (i.e., the original CSI-RS resources) are already activated, an activation MAC CE with the reserved bit 802 equal to 1 may also deactivate the original resources. If the original resources are not activated, they remain not activated for an activation MAC CE with the reserved bit 802 equal to 1. In some embodiments, to maintain backward compatibility, the MAC CE with reserved bit 802 set equal to 0 does not deactivate the spatial adaptation CSI-RS resources when activating the original CSI-RS resources.

Further, a deactivation MAC CE with reserved bit 802 set equal to 1 may deactivate the spatial adaptation CSI-RS resources only. Similarly, a deactivation MAC CE with reserved bit 802 set equal to 0 may deactivate the original CSI-RS resources only. In these embodiments the UE does not expect to be configured with a deactivation MAC CE with reserved bit 802 set equal to 1 when the spatial adaptation CSI-RS resources are not activated and does not expect to be configured with a deactivation MAC CE with reserved bit 802 set equal to 0 when the original resources are not activated. Accordingly, restrictions to prevent such a state may be placed on the network node.

In some embodiments, the additional CSI-RS resources (e.g., the spatial adaptation CSI-RS resources) and the original CSI-RS resources can be simultaneously activated. An activation MAC CE with reserved bit 802 equal to 1 can activate original CSI-RS resources configured in nzp-CSI-RS-Resources and the spatial adaptation CSI-RS resources configured in nzp-CSI-RS-ResourcesForSpatialAdaption-r18. If the original resources configured in nzp-CSI-RS-Resources are already activated, such an activation MAC CE may additionally activate the spatial adaptation CSI-RS resources configured in nzp-CSI-RS-ResourcesForSpatialAdaption-r18. If the original resources are not activated, such an activation MAC CE may activate all the resources configured in the two information elements (IEs) (i.e., nzp-CSI-RS-ResourcesForSpatialAdaption-r18 and nzp-CSI-RS-Resources).

The network node may ensure that there is a sufficient time gap between the two kinds of resources. Additionally, a deactivation MAC CE with reserved bit 802 set equal to 1 may deactivate all resources (e.g., both the spatial adaptation CSI-RS resources and the original CSI-RS resources). In another embodiment, a deactivation MAC CE with reserved bit 802 set equal to 1 may deactivate the original resources only.

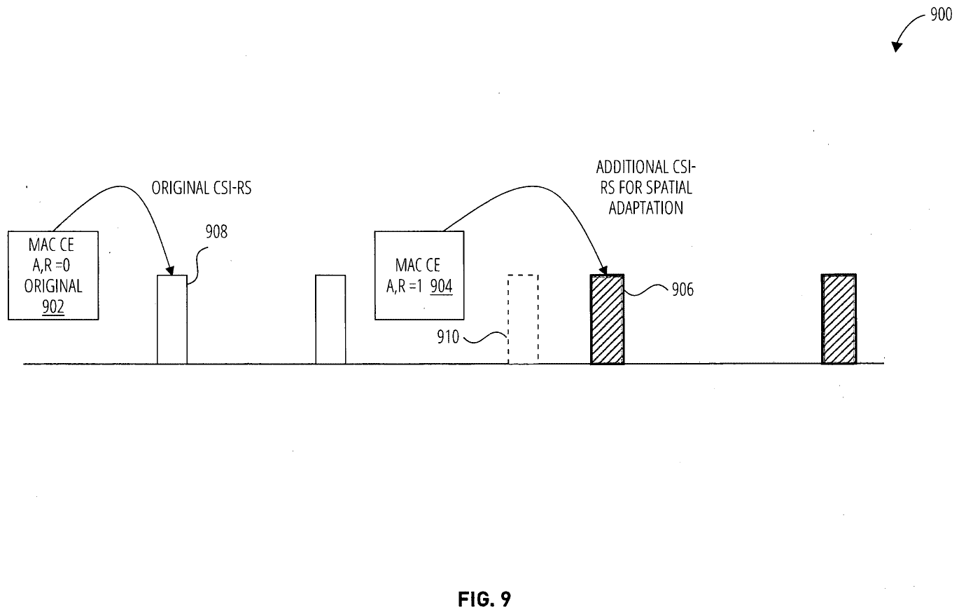

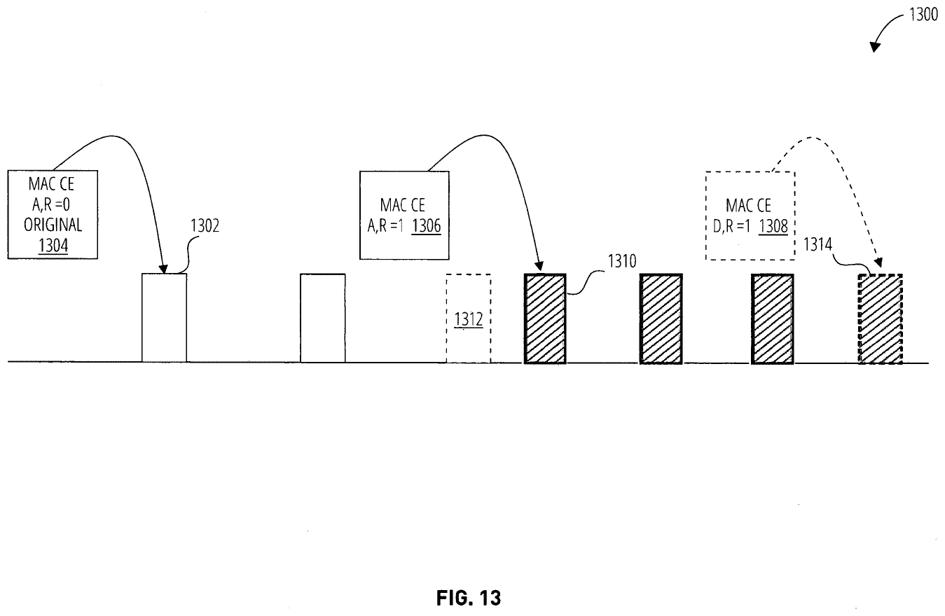

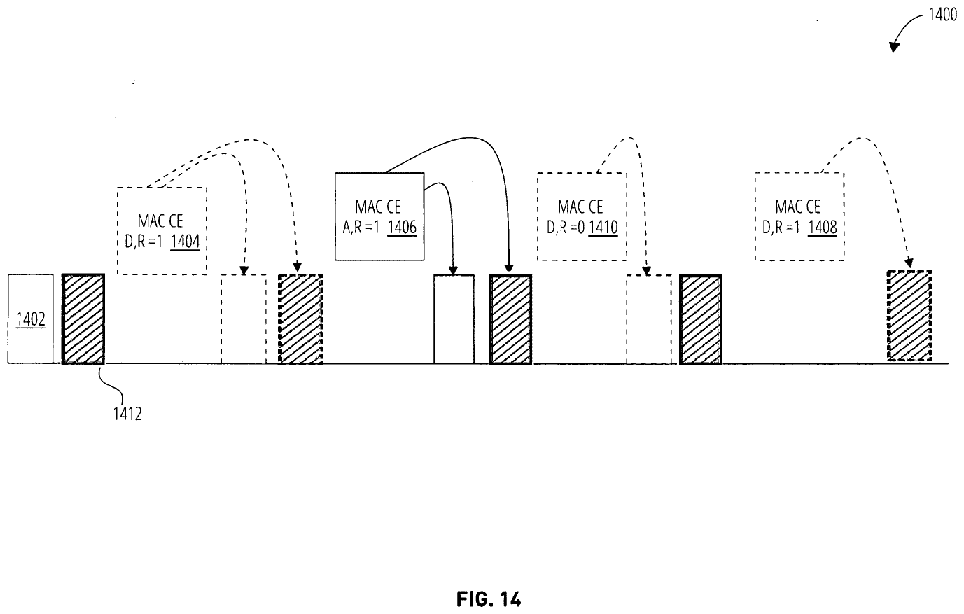

FIGS. 9-12 provide examples of how semi-persistent original CSI-RS resources and spatial adaptation CSI-RS resources may be activated. FIGS. 13-14 provide examples of how semi-persistent original CSI-RS resources and spatial adaptation CSI-RS resources may be deactivated. These timelines are examples of how the MAC CE may activate and deactivate the resources.

FIG. 9 illustrates a timeline 900 of activating semi-persistent original CSI-RS resources 908 and semi-persistent spatial adaptation CSI-RS resources 906 where both resources cannot be activated simultaneously in accordance with some embodiments. As shown, when the network node sends, to the UE, a first activation MAC CE 902 with reserved bit set equal to zero, the original CSI-RS resources 908 are activated. Then when the network node sends a second activation MAC CE 904 with reserved bit set equal to one to the UE, the original CSI-RS resources 908 are deactivated (e.g., deactivated resources 910) and the spatial adaptation CSI-RS resources 906 are activated.

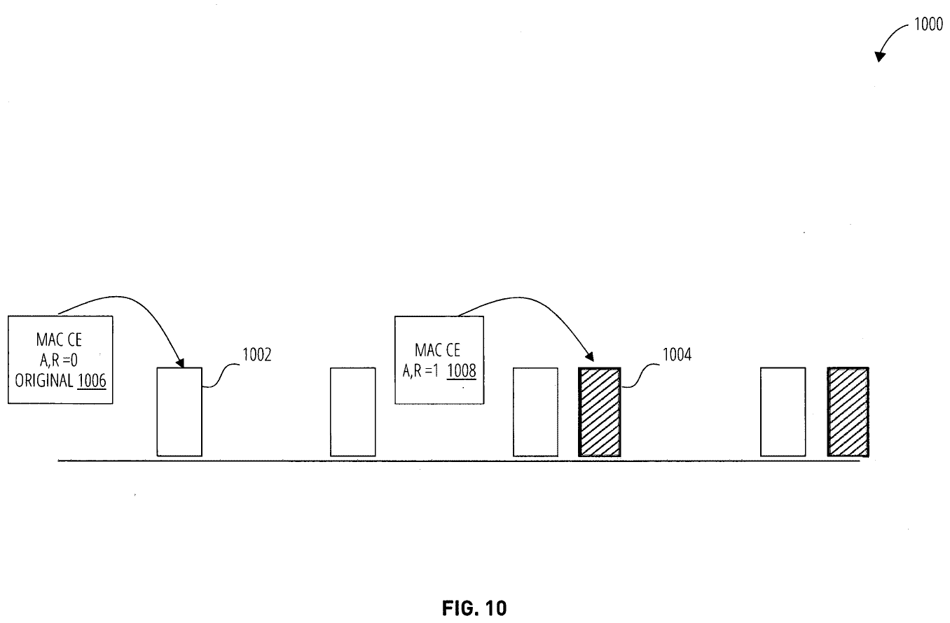

FIG. 10 illustrates a timeline 1000 of activating semi-persistent original CSI-RS resources 1002 and semi-persistent spatial adaptation CSI-RS resources 1004 where both resources can be activated simultaneously in accordance with some embodiments. As shown, when the network node sends a first activation MAC CE 1006 with reserved bit set equal to zero to the UE, the semi-persistent original CSI-RS resources 1002 are activated. Then when the network node sends a second activation MAC CE 1008 with reserved bit set equal to one to the UE, the original CSI-RS resources 908 remain activated and the semi-persistent spatial adaptation CSI-RS resources 1004 are activated.

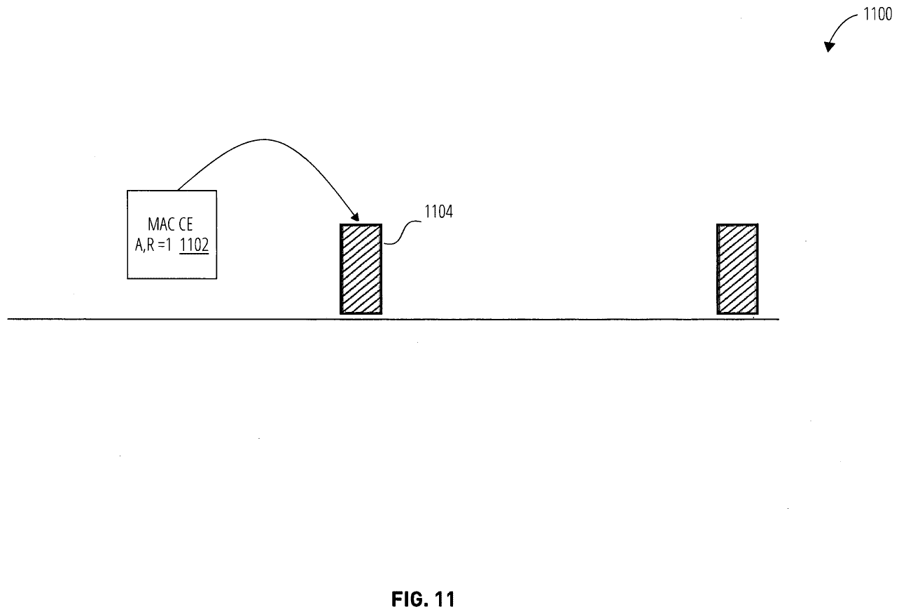

FIG. 11 illustrates a timeline 1100 of activating semi-persistent spatial adaptation CSI-RS resources 1104 where both the original resources and the spatial adaptation CSI-RS resources 1104 cannot be activated simultaneously in accordance with some embodiments. At the beginning of the illustrated timelines 1100, the original CSI-RS resources and the spatial adaptation CSI-RS resources 1104 not activated. The network node sends, to the UE, an activation MAC CE 1102 with reserved bit set equal to one. Based on the activation MAC CE 1102, the spatial adaptation CSI-RS resources 1104 are activated and the CSI-RS original resources remain not activated.

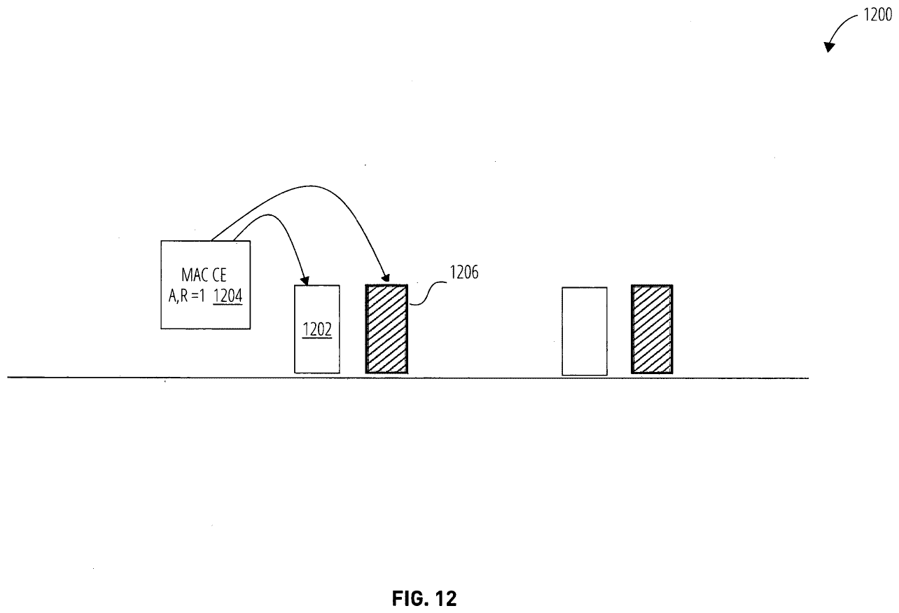

FIG. 12 illustrates a timeline 1200 of activating both the semi-persistent original resources 1202 and the semi-persistent spatial adaptation CSI-RS resources 1206 where both can be activated simultaneously in accordance with some embodiments. At the beginning of the illustrated timelines timeline 1200, the original CSI-RS resources and the spatial adaptation CSI-RS resources 1104 not activated. The network node sends, to the UE, an activation MAC CE 1204 with reserved bit set equal to one. Based on the activation MAC CE 1204, the spatial adaptation CSI-RS resources 1206 and the CSI-RS original resources 1202 are activated.

FIG. 13 illustrates a timeline 1300 of activating and deactivating both semi-persistent original resources 1302 and semi-persistent spatial adaptation CSI-RS resources 1310 in embodiments where both cannot be activated simultaneously. As shown, when the network node sends, to the UE, a first activation MAC CEs 1304 with reserved bit set equal to zero, the semi-persistent original resources 1302 are activated. Then when the network node sends, to the UE, a second activation MAC CE 1306 with reserved bit set equal to one, the semi-persistent original resources 1302 are deactivated (e.g., deactivated resources 1312) and the semi-persistent spatial adaptation CSI-RS resources 1310 are activated. Then when the network node sends, to the UE, a deactivation MAC CE 1308 with reserve bit set to one, the semi-persistent spatial adaptation CSI-RS resources 1310 are deactivated (e.g., deactivated resource 1314).

FIG. 14 illustrates a timeline 1400 of activating and deactivating both semi-persistent original resources 1402 and semi-persistent spatial adaptation CSI-RS resources 1412 in embodiments where both can be activated simultaneously. In the illustrated embodiment, the timeline 1400 begins with both semi-persistent original resources 1402 and semi-persistent spatial adaptation CSI-RS resources 1412 activated. When the network node sends, to the UE, a first deactivation MAC CE 1404 with reserved bit set equal to one, the semi-persistent original resources 1402 and the semi-persistent spatial adaptation CSI-RS resources 1412 are deactivated.

Then, when the network node sends, to the UE, an activation MAC CE 1406 with reserved bit set equal to one, the semi-persistent original resources 1402 and the semi-persistent spatial adaptation CSI-RS resources 1412 are activated. Then when the network node sends, the UE, a second deactivation MAC CE 1410 with reserved bit set equal to zero, the semi-persistent original resources 1402 are deactivated and the semi-persistent spatial adaptation CSI-RS resources 1412 remain activated. Then when the network node sends, the UE, a third deactivation MAC CE 1408 with reserved bit set equal to one, the semi-persistent spatial adaptation CSI-RS resources 1412 are deactivated.

Some embodiments may include separate DCI triggers for aperiodic original CSI-RS resources and aperiodic spatial adaptation CSI-RS resources. For a CSI resource setting configured as aperiodic, the DCI may trigger a resource set for aperiodic transmission. With the current DCI, the whole resource set will be triggered including the original CSI-RS resources and the spatial adaptation CSI-RS resources. Always triggering both resources may not be flexible enough. For instance, the network node may desire to only trigger aperiodic spatial adaptation CSI-RS resources.

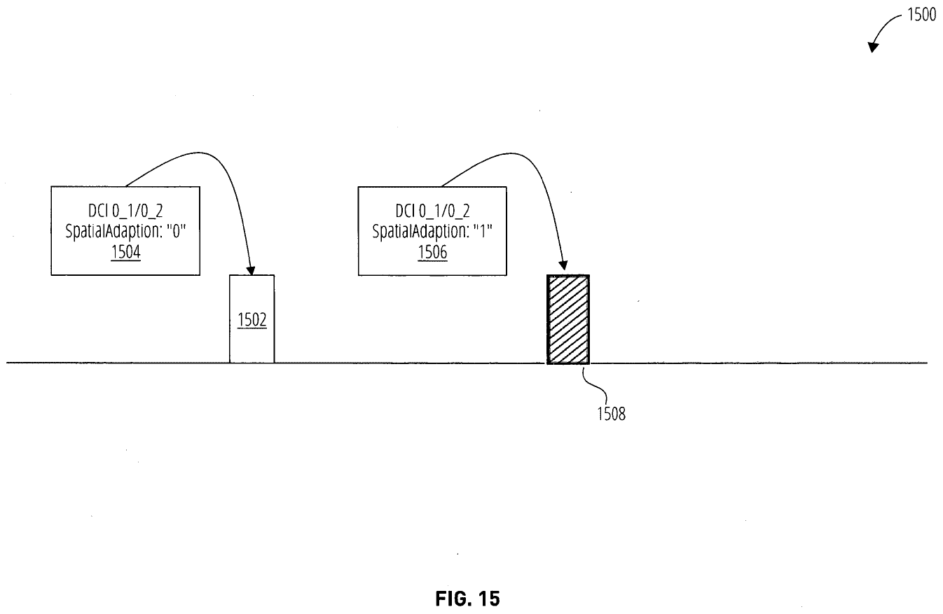

In some embodiments, an indication bit in the DCI filed may be introduced to indicate which resources should be triggered. This indication bit may be either a new bit or may use an existing field. FIG. 15 illustrates an example timeline 1500 where the aperiodic original CSI-RS resources and aperiodic spatial adaptation CSI-RS resources are triggered individually using an indication bit in a DCI in accordance with some embodiments. A “0” value in the indication bit may indicate that the original resources nzp-CSI-RS-Resources in this set are triggered. A “1” value in the indication bit may indicate that the additional resources in nzp-CSI-RS-ResourcesForSpatialAdaption-r18 in this set are triggered.

In the illustration, the indication bit is referred to as SpatialAdaptation. As shown, when a first DCI 1504 with SpatialAdaptation set equal to zero is sent to a UE, the aperiodic original CSI-RS resources 1502 is triggered. Similarly, when a second DCI 1506 with SpatialAdaptation set equal to one is sent to a UE, the aperiodic spatial adaptation CSI-RS resources 1508 are triggered.

In some embodiments, the CSI processing unit (CPU) occupation may be increased if additional resources are configured. For a resource setting that is used for beam management, the CPU counting currently is set to 1. This may not be a sufficient amount of time for a UE to perform additional measurements for additional resources.

Accordingly, for a CSI report with CSI-ReportConfig with higher layer parameter reportQuantity set to ‘cri-RSRP’, CPU occupation may be set to more than 1 (e.g., O_{CPU}=2) if the report is associated with a periodic resourceConfig and nzp-CSI-RS-ResourcesForSpatialAdaption-r18 is configured. If nzp-CSI-RS-ResourcesForSpatialAdaption-r18 is not configured then the CPU occupation may be set to 1 (i.e., O_{CPU}=1).

Similarly, CPU occupation may be set to more than 1 (e.g., O_{CPU}=2) if the report is associated with a semi-persistent resourceConfig and both resources in nzp-CSI-RS-Resources and nzp-CSI-RS-ResourcesForSpatialAdaption-r18 are activated. If only the original resources or the additional resources are activated, the CPU occupation may be set to 1.

In some embodiments, the CPU occupation may be set to 1, if the report is associated with an aperiodic resourceConfig. This may allow sufficient time for the UE since the aperiodic resources may be triggered independently.

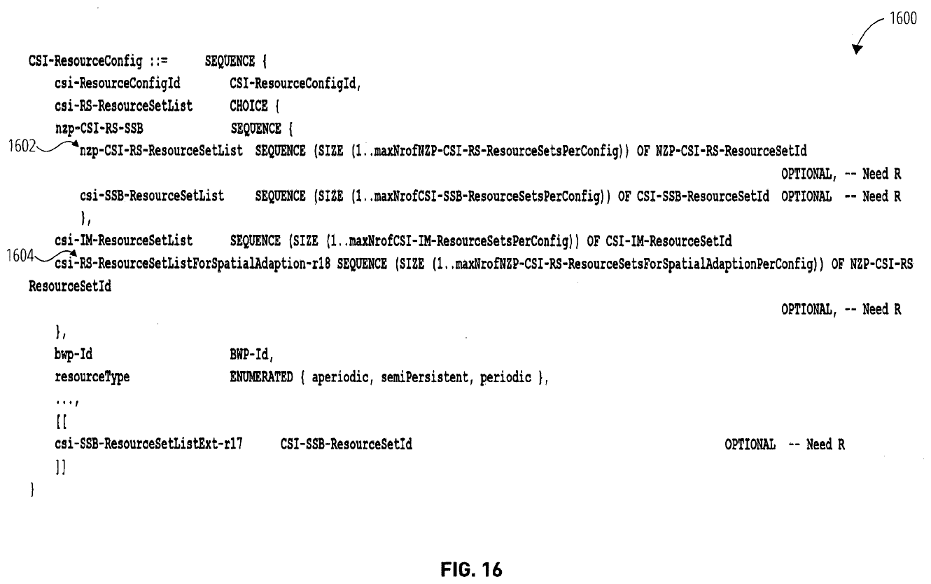

In some embodiments, the network node may indicate separate CSI-RS resource set(s) within one CSI-ResourceConfig information element. FIG. 16 illustrates a CSI-ResourceConfig information element 1600 with both the original resource set 1602 and an additional resource set for spatial adaptation (e. g, spatial adaptation CSI-RS resource set 1604). The network node can configure one or multiple additional CSI-RS resource set(s) for spatial elements adaptation measurement in one CSI-ResourceConfig CSI-ResourceConfig information element 1600.

In the current wireless specification, besides for groupBasedBeamReporting, only one CSI-RS Resource Set can be configured for periodic and semi-persistent CSI resource setting. Therefore, the additional CSI-RS resource sets would require changes to current specification. These changes would introduce greater flexibility to add one or more additional resource sets for spatial adaptation.

In some embodiments, the CSI-RS resources configured in the additional set(s) (e.g., spatial adaptation CSI-RS resource set 1604) may be used for CSI measurement for spatial elements report, where the codepoints in NZP-CSI-RS-ResourceSet IE are not changed. In some embodiments, the spatial adaptation CSI-RS resource set 1604 may have a different spatial mapping than the original resource set 1602. In some embodiments, the number of CSI-RS resources in the spatial adaptation CSI-RS resource set 1604 may be reduced in comparison to the original resource set 1602.

Embodiments using different resource sets may provide a clear separation between the original resources and additional resources for spatial adaptation by placing them into two resource sets. However, this may lead to some duplicated information elements to be configured in the resource sets.

For semipersistent CSI-RS, a MAC CE activation/deactivation may be done per resource set. Therefore, the two resource sets can be activated/deactivated independently or simultaneously. In some embodiments, enhancements could save MAC CE overhead. For example, MAC CE overhead may be reduced by associating one reportConfig IE with two resource sets, where one is the original resource set and the other is the resource set for spatial adaption and the network node may use a reserve bit of the MAC CE similarly as discussed with reference to FIG. 8 for activation/deactivation.

For example, an activation MAC CE with reserved bit set equal to one may activate the spatial adaptation CSI-RS resource set 1604 only. If the original resource set 1602 is already activated, the MAC CE may also deactivate the original resource set 1602. If the original resource set 1602 is not activated, the original resource set 1602 remains not activated. In some embodiments, to maintain backward compatibility, a MAC CE with reserved bit set equal to zero does not deactivate the spatial adaptation CSI-RS resource set 1604 when activating the original resource set 1602.

In some embodiments, a deactivation MAC CE with reserved bit set equal to one deactivates the spatial adaptation CSI-RS resource set 1604 only. A deactivation MAC CE with reserved bit set equal to zero may deactivate the original resource set 1602 only. The UE may not expect to be configured with a deactivation MAC CE with reserved bit set equal to one when the spatial adaptation CSI-RS resource set 1604 is not activated and does not expect to be configured with a deactivation MAC CE with reserved bit set equal to zero when the original resource set 1602 is not activated.

For aperiodic CSI-RS, in some embodiments the CSI-AperiodicTriggerStateList may be used to trigger different resource sets. Each state in the CSI-AperiodicTriggerStateList may include a link between a reportConfig IE and a resource set for channel measurement. In some embodiments a state may be added that links the reportConfig IE and the spatial adaptation CSI-RS resource set 1604. Thus, there may be a state that links one reportConfig to two resource sets, where one of the resource sets is the original resource set 1602 and the other resource set is the spatial adaptation CSI-RS resource set 1604.

Triggering the resource sets may be done independently using an indication bit in the DCI field. The indication bit may be a new field or an existing field and may indicate which resource to trigger. When the indication bit is set to zero it may indicate that the original resource set 1602 is triggered. When the indication bit is set to one it may indicate that the spatial adaptation CSI-RS resource set 1604 is triggered.

In some embodiments, the CPU occupation may be increased if additional resource sets are configured. Accordingly, for a CSI report with CSI-ReportConfig with higher layer parameter reportQuantity set to ‘cri-RSRP’, CPU occupation may be set to one plus the number of resource sets in csi-RS-ResourceSetListForSpatialAdaption-r18 if the report is associated with a periodic resourceConfig and csi-RS-ResourceSetListForSpatialAdaption-r18 is configured. If csi-RS-ResourceSetListForSpatialAdaption-r18 is not configured then the CPU occupation may be set to 1 (i.e., O_{CPU}=1).

The CPU occupation may be set to one if the report is associated with a semi-persistent resourceConfig and no csi-RS-ResourceSetListForSpatialAdaption-r18 is associated with the reportConfig. If the report is associated with csi-RS-ResourceSetListForSpatialAdaption-r18, CPU occupation may be set to the total number of activated resource sets with this reportConfig. In some embodiments, the CPU occupation may be set to 1, if the report is associated with an aperiodic resourceConfig.

In some embodiments, a single CSI-report configuration may indicate two separate CSI-resource configurations. The network node can associate one or multiple additional CSI-ResourceConfig(s) for spatial elements adaptation measurement in one CSI-ReportConfig. Currently, only one CSI-ResourceConfig for channel measurement can be configured per CSI-ReportConfig. Introducing an additional CSI-ResourceConfig may allow for flexibility to support spatial adaptation CSI-RS reports.

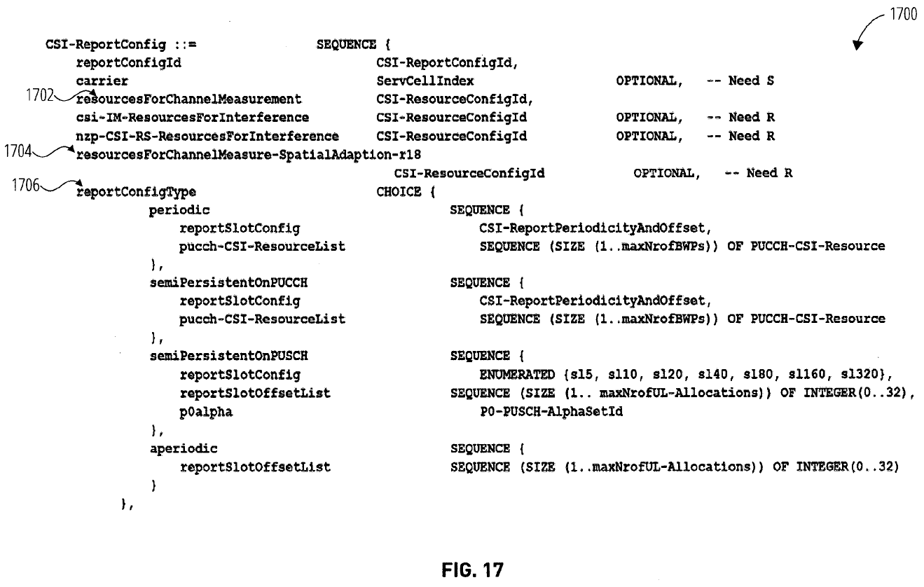

For example, FIG. 17 illustrates a CSI-ReportConfig information element 1700 comprising original CSI-ResourceConfig information element 1702 and spatial adaptation CSI-ResourceConfig information element 1704. The original CSI-ResourceConfig information element 1702 may be used to configure a resource set and resources for a CSI-RS report with all of the ports and spatial elements. The spatial adaptation CSI-ResourceConfig information element 1704 may be used to configure a resource set and resources for a CSI-RS report based on a reduced number of spatial elements.

Adding the spatial adaptation CSI-ResourceConfig information element 1704 is a way to indicate another CSI-RS resource(s) for UE to measure. Within the spatial adaptation CSI-ResourceConfig information element 1704, the network node can configure the following without changing the codepoints in the original CSI-ResourceConfig information element 1702. In some embodiments, the CSI-RS resources of the spatial adaptation CSI-ResourceConfig information element 1704 may have a different spatial mapping than the CSI-RS resources of the original CSI-ResourceConfig information element 1702. In some embodiments, the number of CSI-RS resources in the spatial adaptation CSI-ResourceConfig information element 1704 may be reduced in comparison to the CSI-RS resources of the original CSI-ResourceConfig information element 1702.

Using two CSI-Resource configuration IEs may lead to duplicated configurations. However, it may provide an implementation where the resource type of the two CSI-Resource configuration IEs may be different. This flexibility may allow the original CSI-ResourceConfig information element 1702 and the spatial adaptation CSI-ResourceConfig information element 1704 to have different time domain behaviors.

In some embodiments, the spatial adaptation CSI-ResourceConfig information element 1704 may be required to be configured with the same resourceType as the original CSI-ResourceConfig information element 1702. For example, if the original CSI-ResourceConfig information element 1702 is semi-persistent, the spatial adaptation CSI-ResourceConfig information element 1704 is also semi-persistent.

In some embodiments, for the additional CSI-ResourceConfig(s) (e.g., spatial adaptation CSI-ResourceConfig information element 1704), a different resourceType is supported. The time domain behavior for the additional CSI-ResourceConfig(s) may be the same, and may be less frequent than the original CSI-ResourceConfig information element 1702. For CSI-ReportConfig information element 1700 with reportConfigType 1706 set to semi-persistent, both the original CSI-ResourceConfig information element 1702 and spatial adaptation CSI-ResourceConfig information element 1704 may be semi-persistent. The activation/deactivation may use a MAC CE or DCI as described previously. Additionally, the CPU occupation may be increased.

For CSI-ReportConfig information element 1700 with reportConfigType 1706 set to semiPersistentOnPUCCH or semiPersistentOnPUSCH, the resource types for the original CSI-ResourceConfig information element 1702 and spatial adaptation CSI-ResourceConfig information element 1704 may be as follows. In a first configuration, both of the original CSI-ResourceConfig information element 1702 and the spatial adaptation CSI-ResourceConfig information element 1704 may have a resourceType set to periodic. In a second configuration, the original CSI-ResourceConfig information element 1702 may have a resourceType set to periodic and the 1704 may have a resourceType set to semi-persistent. In a third configuration, the original CSI-ResourceConfig information element 1702 may have a resourceType set to semi-persistent and the spatial adaptation CSI-ResourceConfig information element 1704 may have a resourceType set to semi-persistent. If both are set configured as semipersistent, the activation/deactivation may use a MAC CE as described previously.

For a CSI-ReportConfig information element 1700 with reportConfigType 1706 set to aperiodic, the resource types for the original CSI-ResourceConfig information element 1702 and spatial adaptation CSI-ResourceConfig information element 1704 may be as follows. In a first configuration, both of the original CSI-ResourceConfig information element 1702 and the 1704 may have a resourceType set to periodic. In a second configuration, the original CSI-ResourceConfig information element 1702 may have a resourceType set to periodic and the 1704 may have a resourceType set to semi-persistent. In a second configuration, the original CSI-ResourceConfig information element 1702 may have a resourceType set to periodic and the spatial adaptation CSI-ResourceConfig information element 1704 may have a resourceType set to aperiodic. In a third configuration, the original CSI-ResourceConfig information element 1702 may have a resourceType set to semi-persistent and the spatial adaptation CSI-ResourceConfig information element 1704 may have a resourceType set to semi-persistent. In a fourth configuration, the original CSI-ResourceConfig information element 1702 may have a resourceType set to semi-persistent and the spatial adaptation CSI-ResourceConfig information element 1704 may have a resourceType set to aperiodic. In a third configuration, the original CSI-ResourceConfig information element 1702 may have a resourceType set to aperiodic and the spatial adaptation CSI-ResourceConfig information element 1704 may have a resourceType set to aperiodic. If both are set configured as semipersistent, the activation/deactivation may use a MAC CE as described previously. If both are set configured as semipersistent, the triggering may use a DCI as described previously.

The Activation/Triggering of the original CSI-ResourceConfig information element 1702 and spatial adaptation CSI-ResourceConfig information element 1704 for embodiments where two CSI-Resource configuration IEs are associated with one CSI-Report configuration IE may be similar to previously described embodiments.

For example, for semipersistent CSI-RS, a MAC CE activation/deactivation may be done per resource set. Therefore, the two resource sets of the two resource configurations can be activated/deactivated independently or simultaneously. For example, the network node may use a reserve bit of the MAC CE similarly as discussed with reference to FIG. 8 for activation/deactivation.

For example, an activation MAC CE with reserved bit set equal to one may activate the spatial adaptation CSI-ResourceConfig information element 1704 only. If the original CSI-ResourceConfig information element 1702 is already activated, the MAC CE may also deactivate the original CSI-ResourceConfig information element 1702. If the original CSI-ResourceConfig information element 1702 is not activated, the original CSI-ResourceConfig information element 1702 remains not activated.

In some embodiments, a deactivation MAC CE with reserved bit set equal to one deactivates the spatial adaptation CSI-ResourceConfig information element 1704 only. A deactivation MAC CE with reserved bit set equal to zero may deactivate the original CSI-ResourceConfig information element 1702 only.

Triggering the resource configurations sets may be done independently using an indication bit in the DCI field. The indication bit may be a new field or an existing field and may indicate which resource to trigger. When the indication bit is set to zero it may indicate that the original CSI-ResourceConfig information element 1702 is triggered. When the indication bit is set to one it may indicate that the spatial adaptation CSI-ResourceConfig information element 1704 is triggered.

In some embodiments, the CPU occupation may be increased if additional resource configurations are configured. For a CSI report with CSI-ReportConfig with higher layer parameter reportQuantity set to ‘cri-RSRP’, CPU occupation may be set to the number of periodic resource sets plus a number of activated semi-persistentresource sets plus a number of triggered aperiodic resource sets.

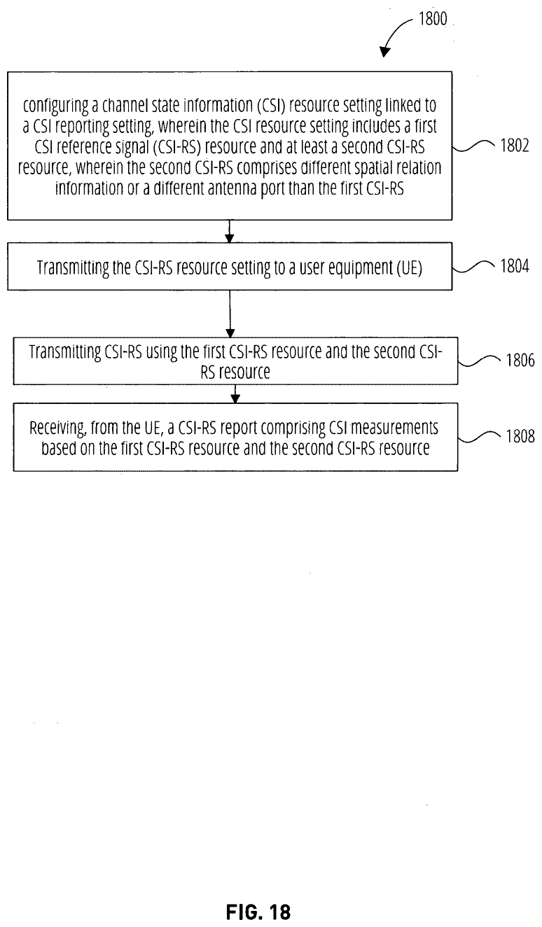

FIG. 18 illustrates a flowchart of a method 1800 of a network node, according to embodiments herein. The illustrated method 1800 includes configuring 1802 a CSI resource setting linked to a CSI reporting setting, wherein the CSI resource setting includes a first CSI-RS)resource and at least a second CSI-RS resource, wherein the second CSI-RS comprises different spatial relation information or a different antenna port than the first CSI-RS. The method 1800 further includes transmitting 1804 the CSI-RS resource setting to a UE.

The method 1800 further includes transmitting 1806 CSI-RS using the first CSI-RS resource and the second CSI-RS resource.

The method 1800 further includes receiving 1808 from the UE, a CSI-RS report comprising CSI measurements based on the first CSI-RS resource and the second CSI-RS resource.

In some embodiments of the method 1800, the first CSI-RS resources and the second CSI-RS resources are configured in a same CSI-RS resource set.

In some embodiments of the method 1800, the first CSI-RS resources are configured in a first CSI-RS resource set, and the second CSI-RS resources are configured in a second CSI-RS resource set.

In some embodiments of the method 1800, the number of CSI-RS resources in the second resource set is smaller than that in the first resource set.

In some embodiments, the method 1800 further comprises transmitting a MAC CE to the UE comprising an indication of whether one or both of the first CSI-RS resources and the second CSI-RS resources are activated. In some embodiments, the first CSI-RS resources and the second CSI-RS resources cannot be activated simultaneously. In some embodiments, activating the second CSI-RS resources also deactivates the first CSI-RS resources.

In some embodiments, the method 1800 further comprises transmitting a DCI to the UE comprising an indication that the first CSI-RS resources or that the second CSI-RS resources are activated for an aperiodic transmission.

In some embodiments, the method 1800 further comprises setting a CPU occupation to more than one if the CSI-RS report configuration is for a semi-persistent CSI-RS report and both the first CSI-RS resources and the second CSI-RS resources are activated.

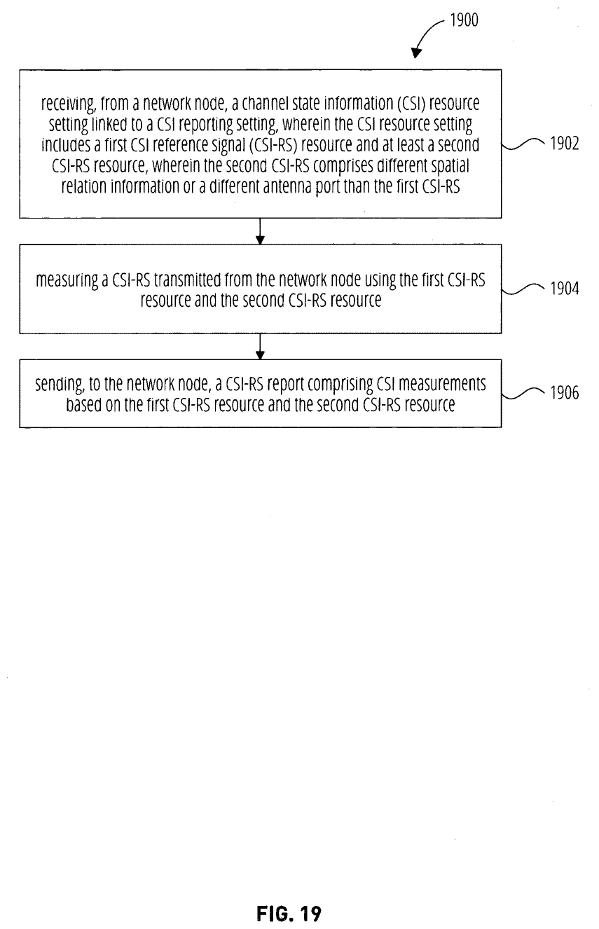

FIG. 19 illustrates a flowchart of a method 1900 of a UE, according to embodiments herein. The illustrated method 1900 includes receiving 1902 a CSI resource setting linked to a CSI reporting setting, wherein the CSI resource setting includes a first CSI-RS resource and at least a second CSI-RS resource, wherein the second CSI-RS comprises different spatial relation information or a different antenna port than the first CSI-RS.

The method 1900 further includes measuring 1904 a CSI-RS transmitted from the network node using the first CSI-RS resource and the second CSI-RS.

The method 1900 further includes sending 1906, to the network node, a CSI-RS report comprising CSI measurements based on the first CSI-RS resource and the second CSI-RS resource.

In some embodiments of the method 1900, the first CSI-RS resources and the second CSI-RS resources are configured in a same CSI-RS resource set.

In some embodiments of the method 1900, the first CSI-RS resources are configured in a first CSI-RS resource set, and the second CSI-RS resources are configured in a second CSI-RS resource set.

In some embodiments, the method 1900 further comprises receiving a MAC CE from the network node comprising an indication of whether one or both of the first CSI-RS resources and the second CSI-RS resources are activated. In some embodiments the first CSI-RS resources and the second CSI-RS resources can be activated simultaneously. In some embodiments activating the second CSI-RS resources also deactivates the first CSI-RS resources.

In some embodiments, the method 1900 further comprises receiving a DCI from the network node comprising an indication that the first CSI-RS resources or that the second CSI-RS resources are activated for an aperiodic transmission.

In some embodiments, the method 1900 further comprises setting a CPU occupation to more than one if the CSI-RS report configuration is for a semi-persistent CSI-RS report and both the first CSI-RS resources and the second CSI-RS resources are activated.

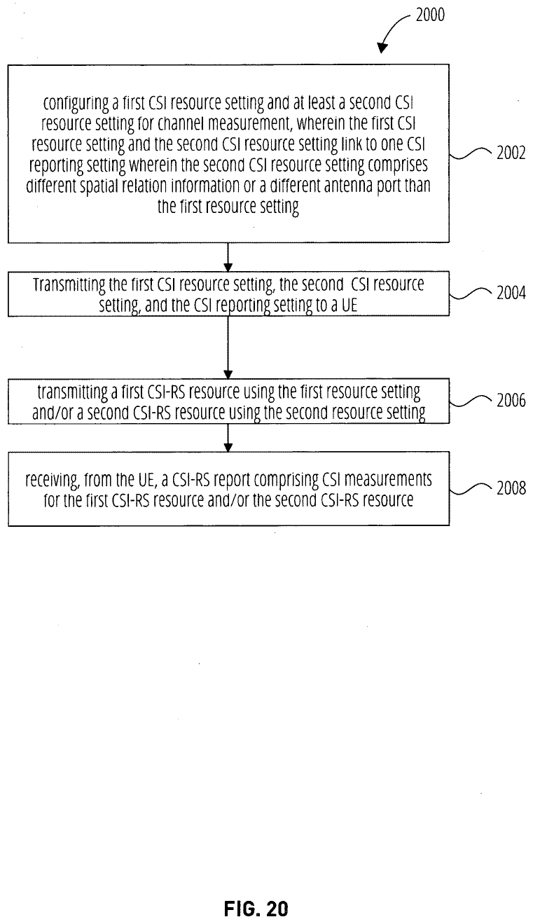

FIG. 20 illustrates a flowchart of a method 2000 of a network node, according to some embodiments herein. The illustrated method 2000 includes, configuring 2002 a first CSI resource setting and at least a second CSI resource setting for channel measurement, wherein the first CSI resource setting and the second CSI resource setting link to one CSI reporting setting wherein the second CSI resource setting comprises different spatial relation information or a different antenna port than the first resource setting

The method 2000 further includes transmitting 2004 the first CSI resource setting, the second CSI resource setting, and the CSI reporting setting to a UE. The method 2000 further includes transmitting 2006 a first CSI-RS resource using the first resource setting and/or a second CSI-RS resource using the second resource setting. The method 2000 further includes receiving 2008, from the UE, a CSI-RS report comprising CSI measurements for the first CSI-RS resource and/or the second CSI-RS resource.

In some embodiments of the method 2000, the original CSI-Resource configuration IE and the spatial adaptation CSI-Resource configuration IE are configured with different time domain behaviors.

In some embodiments of the method 2000, when the CSI reporting setting is periodic, both the first CSI resource setting and the second CSI resource setting are periodic.

In some embodiments of the method 2000, when the CSI reporting setting is semi-persistent, when the first resource setting is periodic, the second resource setting is periodic or semi-persistent; and when the first resource setting is semi-persistent, the second resource setting is semi-persistent.

In some embodiments of the method 2000, when the CSI reporting setting is aperiodic, when the first resource setting is periodic, the second resource setting is periodic, semi-persistent, or aperiodic; when the first resource setting is semi-persistent, the second resource setting is semi-persistent or aperiodic; and when the first resource setting is aperiodic, the second resource setting is aperiodic.

In some embodiments, the method 2000 further comprises transmitting a MAC CE to the UE comprising an indication of whether one or both of the first CSI-Resource configuration IE and the second CSI-Resource configuration IE are activated.

In some embodiments, the method 2000 further comprises transmitting a DCI to the UE comprising an indication that the first CSI-Resource configuration IE or that the second CSI-Resource configuration IE is triggered for an aperiodic transmission.

In some embodiments, the method 2000 further comprises setting CPU occupation equal to a number of periodic resource sets plus a number of activated semi-persistent resource sets plus a number of triggered aperiodic resource sets.

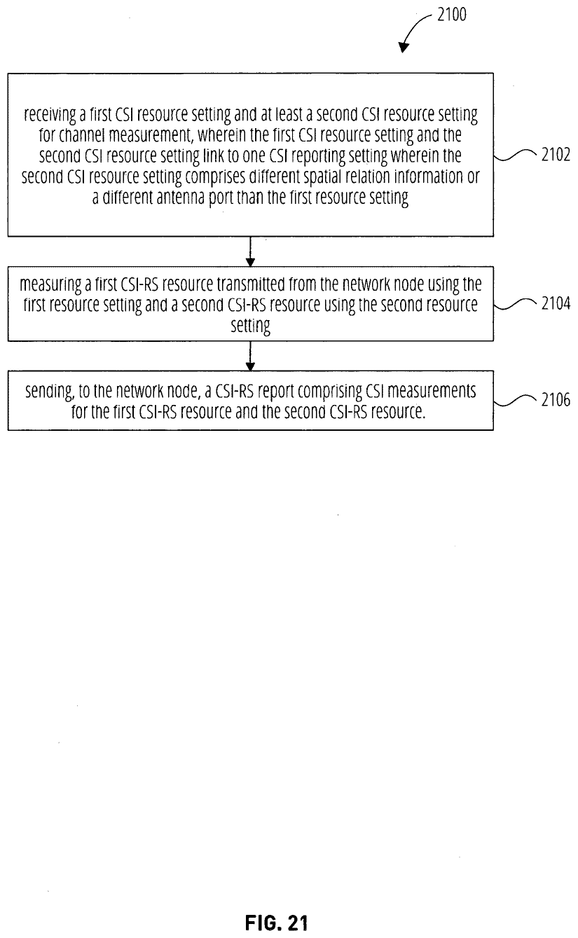

FIG. 21 illustrates a flowchart of a method 2100 of a UE, according to some embodiments herein. The illustrated method 2100 includes receiving 2102 a first CSI resource setting and at least a second CSI resource setting for channel measurement, wherein the first CSI resource setting and the second CSI resource setting link to one CSI reporting setting wherein the second CSI resource setting comprises different spatial relation information or a different antenna port than the first resource setting. The method 2100 further includes measuring 2104 a first CSI-RS resource transmitted from the network node using the first resource setting and a second CSI-RS resource using the second resource setting. The method 2100 further includes sending 2106, to the network node, a CSI-RS report comprising CSI measurements for the first CSI-RS resource and the second CSI-RS resource.

In some embodiments of the method 2100, the first CSI-Resource configuration IE and the second CSI-Resource configuration IE are configured with different time domain behaviors.

In some embodiments of the method 2000, when the CSI reporting setting is periodic, both the first CSI resource setting and the second CSI resource setting are periodic.

In some embodiments of the method 2000, when the CSI reporting setting is semi-persistent, when the first resource setting is periodic, the second resource setting is periodic or semi-persistent; and when the first resource setting is semi-persistent, the second resource setting is semi-persistent.

In some embodiments of the method 2000, when the CSI reporting setting is aperiodic, when the first resource setting is periodic, the second resource setting is periodic, semi-persistent, or aperiodic; when the first resource setting is semi-persistent, the second resource setting is semi-persistent or aperiodic; and when the first resource setting is aperiodic, the second resource setting is aperiodic.

In some embodiments, the method 2100 further comprises receiving a MAC CE from the network node comprising an indication of whether one or both of the first CSI-Resource configuration IE and the second CSI-Resource configuration IE are activated.

In some embodiments, the method 2100 further comprises receiving a DCI from the network node comprising an indication that the first CSI-Resource configuration IE or that the second CSI-Resource configuration IE is triggered for an aperiodic transmission.

In some embodiments, the method 2100 further comprises setting CPU occupation equal to a number of periodic resource sets plus a number of activated semi-persistent resource sets plus a number of triggered aperiodic resource sets.

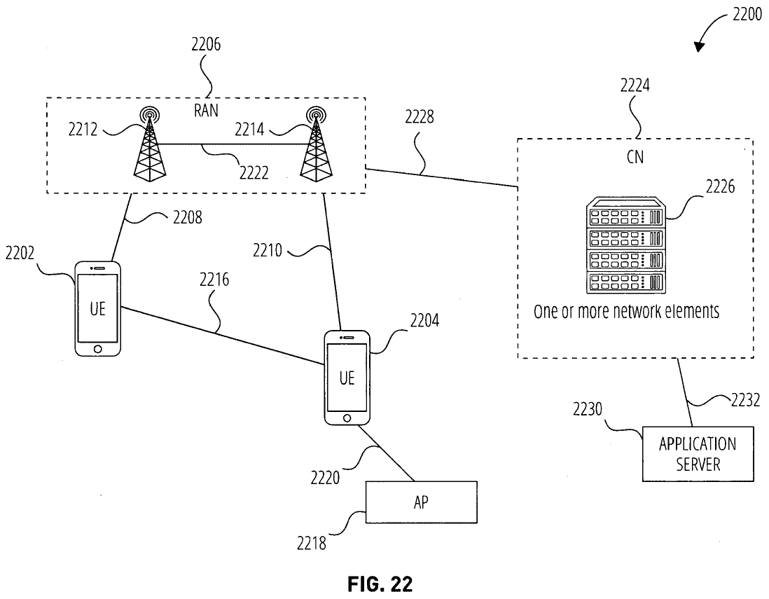

FIG. 22 illustrates an example architecture of a wireless communication system 2200, according to embodiments disclosed herein. The following description is provided for an example wireless communication system 2200 that operates in conjunction with the LTE system standards and/or 5G or NR system standards as provided by 3GPP technical specifications.

As shown by FIG. 22, the wireless communication system 2200 includes UE 2202 and UE 2204 (although any number of UEs may be used). In this example, the UE 2202 and the UE 2204 are illustrated as smartphones (e.g., handheld touchscreen mobile computing devices connectable to one or more cellular networks), but may also comprise any mobile or non-mobile computing device configured for wireless communication.

The UE 2202 and UE 2204 may be configured to communicatively couple with a RAN 2206. In embodiments, the RAN 2206 may be NG-RAN, E-UTRAN, etc. The UE 2202 and UE 2204 utilize connections (or channels) (shown as connection 2208 and connection 2210, respectively) with the RAN 2206, each of which comprises a physical communications interface. The RAN 2206 can include one or more base stations (such as base station 2212 and base station 2214) that enable the connection 2208 and connection 2210.

In this example, the connection 2208 and connection 2210 are air interfaces to enable such communicative coupling, and may be consistent with RAT(s) used by the RAN 2206, such as, for example, an LTE and/or NR.

In some embodiments, the UE 2202 and UE 2204 may also directly exchange communication data via a sidelink interface 2216. The UE 2204 is shown to be configured to access an access point (shown as AP 2218) via connection 2220. By way of example, the connection 2220 can comprise a local wireless connection, such as a connection consistent with any IEEE 802.11 protocol, wherein the AP 2218 may comprise a Wi-Fi® router. In this example, the AP 2218 may be connected to another network (for example, the Internet) without going through a CN 2224.

In embodiments, the UE 2202 and UE 2204 can be configured to communicate using orthogonal frequency division multiplexing (OFDM) communication signals with each other or with the base station 2212 and/or the base station 2214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2212 or base station 2214 may be implemented as one or more software entities running on server computers as part of a virtual network. In addition, or in other embodiments, the base station 2212 or base station 2214 may be configured to communicate with one another via interface 2222. In embodiments where the wireless communication system 2200 is an LTE system (e.g., when the CN 2224 is an EPC), the interface 2222 may be an X2 interface. The X2 interface may be defined between two or more base stations (e.g., two or more eNBs and the like) that connect to an EPC, and/or between two eNBs connecting to the EPC. In embodiments where the wireless communication system 2200 is an NR system (e.g., when CN 2224 is a 5GC), the interface 2222 may be an Xn interface. The Xn interface is defined between two or more base stations (e.g., two or more gNBs and the like) that connect to 5GC, between a base station 2212 (e.g., a gNB) connecting to 5GC and an eNB, and/or between two eNBs connecting to 5GC (e.g., CN 2224).

The RAN 2206 is shown to be communicatively coupled to the CN 2224. The CN 2224 may comprise one or more network elements 2226, which are configured to offer various data and telecommunications services to customers/subscribers (e.g., users of UE 2202 and UE 2204) who are connected to the CN 2224 via the RAN 2206. The components of the CN 2224 may be implemented in one physical device or separate physical devices including components to read and execute instructions from a machine-readable or computer-readable medium (e.g., a non-transitory machine-readable storage medium).

In embodiments, the CN 2224 may be an EPC, and the RAN 2206 may be connected with the CN 2224 via an S1 interface 2228. In embodiments, the S1 interface 2228 may be split into two parts, an S1 user plane (S1-U) interface, which carries traffic data between the base station 2212 or base station 2214 and a serving gateway (S-GW), and the S1-MME interface, which is a signaling interface between the base station 2212 or base station 2214 and mobility management entities (MMEs).

In embodiments, the CN 2224 may be a 5GC, and the RAN 2206 may be connected with the CN 2224 via an NG interface 2228. In embodiments, the NG interface 2228 may be split into two parts, an NG user plane (NG-U) interface, which carries traffic data between the base station 2212 or base station 2214 and a user plane function (UPF), and the S1 control plane (NG-C) interface, which is a signaling interface between the base station 2212 or base station 2214 and access and mobility management functions (AMFs).

Generally, an application server 2230 may be an element offering applications that use internet protocol (IP) bearer resources with the CN 2224 (e.g., packet switched data services). The application server 2230 can also be configured to support one or more communication services (e.g., VoIP sessions, group communication sessions, etc.) for the UE 2202 and UE 2204 via the CN 2224. The application server 2230 may communicate with the CN 2224 through an IP communications interface 2232.

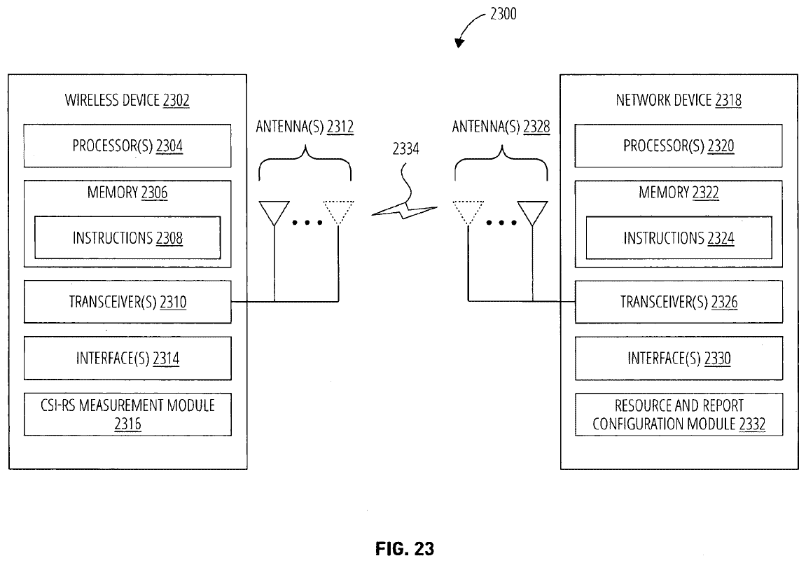

FIG. 23 illustrates a system 2300 for performing signaling 2334 between a wireless device 2302 and a network device 2318, according to embodiments disclosed herein. The system 2300 may be a portion of a wireless communications system as herein described. The wireless device 2302 may be, for example, a UE of a wireless communication system. The network device 2318 may be, for example, a base station (e.g., an eNB or a gNB) of a wireless communication system.

The wireless device 2302 may include one or more processor(s) 2304. The processor(s) 2304 may execute instructions such that various operations of the wireless device 2302 are performed, as described herein. The processor(s) 2304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2302 may include a memory 2306. The memory 2306 may be a non-transitory computer-readable storage medium that stores instructions 2308 (which may include, for example, the instructions being executed by the processor(s) 2304). The instructions 2308 may also be referred to as program code or a computer program. The memory 2306 may also store data used by, and results computed by, the processor(s) 2304.

The wireless device 2302 may include one or more transceiver(s) 2310 that may include radio frequency (RF) transmitter and/or receiver circuitry that use the antenna(s) 2312 of the wireless device 2302 to facilitate signaling (e.g., the signaling 2334) to and/or from the wireless device 2302 with other devices (e.g., the network device 2318) according to corresponding RATs.

The wireless device 2302 may include one or more antenna(s) 2312 (e.g., one, two, four, or more). For embodiments with multiple antenna(s) 2312, the wireless device 2302 may leverage the spatial diversity of such multiple antenna(s) 2312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2302 may be accomplished according to precoding (or digital beamforming) that is applied at the wireless device 2302 that multiplexes the data streams across the antenna(s) 2312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2302 may implement analog beamforming techniques, whereby phases of the signals sent by the antenna(s) 2312 are relatively adjusted such that the (joint) transmission of the antenna(s) 2312 can be directed (this is sometimes referred to as beam steering).

The wireless device 2302 may include one or more interface(s) 2314. The interface(s) 2314 may be used to provide input to or output from the wireless device 2302. For example, a wireless device 2302 that is a UE may include interface(s) 2314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 2310/antenna(s) 2312 already described) that allow for communication between the UE and other devices and may operate according to known protocols (e.g., Wi-Fi®, Bluetooth®, and the like).

The wireless device 2302 may include a CSI-RS measurement module 2316. The CSI-RS measurement module 2316 may be implemented via hardware, software, or combinations thereof. For example, the CSI-RS measurement module 2316 may be implemented as a processor, circuit, and/or instructions 2308 stored in the memory 2306 and executed by the processor(s) 2304. In some examples, the CSI-RS measurement module 2316 may be integrated within the processor(s) 2304 and/or the transceiver(s) 2310. For example, the CSI-RS measurement module 2316 may be implemented by a combination of software components (e.g., executed by a DSP or a general processor) and hardware components (e.g., logic gates and circuitry) within the processor(s) 2304 or the transceiver(s) 2310.

The CSI-RS measurement module 2316 may be used for various aspects of the present disclosure, for example, aspects of FIGS. 7-21. The CSI-RS measurement module 2316 is configured to receive configurations from the network, measure CSI-RS (including CSI-RS using spatial adaptation resources), and report the measurements to the network device 2318.

The network device 2318 may include one or more processor(s) 2320. The processor(s) 2320 may execute instructions such that various operations of the network device 2318 are performed, as described herein. The processor(s) 2320 may include one or more baseband processors implemented using, for example, a CPU, a DSP, an ASIC, a controller, an FPGA device, another hardware device, a firmware device, or any combination thereof configured to perform the operations described herein.

The network device 2318 may include a memory 2322. The memory 2322 may be a non-transitory computer-readable storage medium that stores instructions 2324 (which may include, for example, the instructions being executed by the processor(s) 2320). The instructions 2324 may also be referred to as program code or a computer program. The memory 2322 may also store data used by, and results computed by, the processor(s) 2320.

The network device 2318 may include one or more transceiver(s) 2326 that may include RF transmitter and/or receiver circuitry that use the antenna(s) 2328 of the network device 2318 to facilitate signaling (e.g., the signaling 2334) to and/or from the network device 2318 with other devices (e.g., the wireless device 2302) according to corresponding RATs.

The network device 2318 may include one or more antenna(s) 2328 (e.g., one, two, four, or more). In embodiments having multiple antenna(s) 2328, the network device 2318 may perform MIMO, digital beamforming, analog beamforming, beam steering, etc., as has been described.

The network device 2318 may include one or more interface(s) 2330. The interface(s) 2330 may be used to provide input to or output from the network device 2318. For example, a network device 2318 that is a base station may include interface(s) 2330 made up of transmitters, receivers, and other circuitry (e.g., other than the transceiver(s) 2326/antenna(s) 2328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2318 may include a resource and report configuration module 2332. The resource and report configuration module 2332 may be implemented via hardware, software, or combinations thereof. For example, the resource and report configuration module 2332 may be implemented as a processor, circuit, and/or instructions 2324 stored in the memory 2322 and executed by the processor(s) 2320. In some examples, the resource and report configuration module 2332 may be integrated within the processor(s) 2320 and/or the transceiver(s) 2326. For example, the resource and report configuration module 2332 may be implemented by a combination of software components (e.g., executed by a DSP or a general processor) and hardware components (e.g., logic gates and circuitry) within the processor(s) 2320 or the transceiver(s) 2326.

The resource and report configuration module 2332 may be used for various aspects of the present disclosure, for example, aspects of FIGS. 7-21. The Resource and report configuration module 2332 is configured to create resource configurations, resource set configurations, and resource setting configurations to support CSI-RS measurements for spatial elements adaptation.

Embodiments contemplated herein include an apparatus comprising means to perform one or more elements of the method 1900 and method 2100. This apparatus may be, for example, an apparatus of a UE (such as a wireless device 2302 that is a UE, as described herein).

Embodiments contemplated herein include one or more non-transitory computer-readable media comprising instructions to cause an electronic device, upon execution of the instructions by one or more processors of the electronic device, to perform one or more elements of the method 1900 and method 2100. This non-transitory computer-readable media may be, for example, a memory of a UE (such as a memory 2306 of a wireless device 2302 that is a UE, as described herein).

Embodiments contemplated herein include an apparatus comprising logic, modules, or circuitry to perform one or more elements of the method 1900 and method 2100. This apparatus may be, for example, an apparatus of a UE (such as a wireless device 2302 that is a UE, as described herein).

Embodiments contemplated herein include an apparatus comprising: one or more processors and one or more computer-readable media comprising instructions that, when executed by the one or more processors, cause the one or more processors to perform one or more elements of the method 1900 and method 2100. This apparatus may be, for example, an apparatus of a UE (such as a wireless device 2302 that is a UE, as described herein).

Embodiments contemplated herein include a signal as described in or related to one or more elements of the method 1900 and method 2100.

Embodiments contemplated herein include a computer program or computer program product comprising instructions, wherein execution of the program by a processor is to cause the processor to carry out one or more elements of the method 1900 and method 2100. The processor may be a processor of a UE (such as a processor(s) 2304 of a wireless device 2302 that is a UE, as described herein). These instructions may be, for example, located in the processor and/or on a memory of the UE (such as a memory 2306 of a wireless device 2302 that is a UE, as described herein).

Embodiments contemplated herein include an apparatus comprising means to perform one or more elements of the method 1800 and method 2000. This apparatus may be, for example, an apparatus of a base station (such as a network device 2318 that is a base station, as described herein).

Embodiments contemplated herein include one or more non-transitory computer-readable media comprising instructions to cause an electronic device, upon execution of the instructions by one or more processors of the electronic device, to perform one or more elements of the method 1800 and method 2000. This non-transitory computer-readable media may be, for example, a memory of a base station (such as a memory 2306 of a network device 2318 that is a base station, as described herein).

Embodiments contemplated herein include an apparatus comprising logic, modules, or circuitry to perform one or more elements of the method 1800 and method 2000. This apparatus may be, for example, an apparatus of a base station (such as a network device 2318 that is a base station, as described herein).

Embodiments contemplated herein include an apparatus comprising: one or more processors and one or more computer-readable media comprising instructions that, when executed by the one or more processors, cause the one or more processors to perform one or more elements of the method 1800 and method 2000. This apparatus may be, for example, an apparatus of a base station (such as a network device 2318 that is a base station, as described herein).

Embodiments contemplated herein include a signal as described in or related to one or more elements of the method 1800 and method 2000.

Embodiments contemplated herein include a computer program or computer program product comprising instructions, wherein execution of the program by a processing element is to cause the processing element to carry out one or more elements of the method 1800 and method 2000. The processor may be a processor of a base station (such as a processor(s) 2320 of a network device 2318 that is a base station, as described herein). These instructions may be, for example, located in the processor and/or on a memory of the base station (such as a memory 2322 of a network device 2318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
configuring a first CSI resource setting and at least a second CSI resource setting for channel measurement, wherein the first CSI resource setting and the second CSI resource setting link to one CSI reporting setting wherein the second CSI resource setting comprises different spatial relation information or a different antenna port than the first resource setting;
transmitting the first CSI resource setting, the second CSI resource setting, and the CSI reporting setting to a user equipment (UE);
transmitting a first CSI-RS resource using the first resource setting and/or a second CSI-RS resource using the second resource setting; and
receiving, from the UE, a CSI-RS report comprising CSI measurements for the first CSI-RS resource and/or the second CSI-RS resource.

2. The method of claim 1, wherein the first CSI resource setting and the second CSI-Resource setting are configured with different time domain behaviors.3. The method of claim 1, wherein when the CSI reporting setting is periodic, both the first CSI resource setting and the second CSI resource setting are periodic.

3. The method of claim 1, wherein when the CSI reporting setting is semi-persistent,
when the first resource setting is periodic, the second resource setting is periodic or semi-persistent; and
when the first resource setting is semi-persistent, the second resource setting is semi-persistent.

4. The method of claim 1, wherein when the CSI reporting setting is aperiodic,
when the first resource setting is periodic, the second resource setting is periodic, semi-persistent, or aperiodic;
when the first resource setting is semi-persistent, the second resource setting is semi-persistent or aperiodic; and
when the first resource setting is aperiodic, the second resource setting is aperiodic.

5. The method of claim 1, further comprising transmitting a Medium Access Control (MAC) control element (CE) to the UE comprising an indication of whether one or both of the first CSI-Resource configuration IE and the second CSI-Resource configuration IE are activated.

6. The method of claim 1, further comprising transmitting a downlink control information (DCI) to the UE comprising an indication that the first CSI-Resource configuration IE or that the second CSI-Resource configuration IE is triggered for an aperiodic transmission.

7. The method of claim 1, further comprising setting CPU occupation equal to a number of periodic resource sets plus a number of activated semi-persistent resource sets plus a number of triggered aperiodic resource sets if the CSI-RS reporting setting is for a first CSI-RS report.

8. The method of claim 7, where the first CSI-RS report comprises a reportQuantity set to reportQuantity set to ‘cri-RSRP’, ‘ssb-Index-RSRP’, ‘cri-SINR’, ‘ssb-Index-SINR’, ‘cri-RSRP-Capability[Set]Index’, ‘ssb-Index-RSRP-Capability[Set]Index’, ‘cri-SINR-Capability[Set]Index’, ‘ssb-Index-SINR-Capability[Set]Index’ or ‘none’ (and CSI-RS-ResourceSet with higher layer parameter trs-Info not configured).

9. A method for a user equipment (UE), the method comprising:
receiving a first CSI resource setting and at least a second CSI resource setting for channel measurement, wherein the first CSI resource setting and the second CSI resource setting link to one CSI reporting setting wherein the second CSI resource setting comprises different spatial relation information or a different antenna port than the first resource setting;
measuring a first CSI-RS resource transmitted from the network node using the first resource setting and a second CSI-RS resource using the second resource setting; and
sending, to the network node, a CSI-RS report comprising CSI measurements for the first CSI-RS resource and the second CSI-RS resource.

10. The method of claim 9, wherein the first CSI resource setting and the second CSI-Resource setting are configured with different time domain behaviors.

11. The method of claim 9, wherein when the CSI reporting setting is periodic, both the first CSI resource setting and the second CSI resource setting are periodic.

12. The method of claim 9, wherein when the CSI reporting setting is semi-persistent,
when the first resource setting is periodic, the second resource setting is periodic or semi-persistent; and
when the first resource setting is semi-persistent, the second resource setting is semi-persistent.

13. The method of claim 9, wherein when the CSI reporting setting is aperiodic,
when the first resource setting is periodic, the second resource setting is periodic, semi-persistent, or aperiodic;
when the first resource setting is semi-persistent, the second resource setting is semi-persistent or aperiodic; and
when the first resource setting is aperiodic, the second resource setting is aperiodic.

14. The method of claim 9, further comprising receiving a Medium Access Control (MAC) control element (CE) from the network node comprising an indication of whether one or both of the first CSI-Resource configuration IE and the second CSI-Resource configuration IE are activated.

15. The method of claim 9, further comprising receiving a downlink control information (DCI) from the network node comprising an indication that the first CSI-Resource configuration IE or that the second CSI-Resource configuration IE is triggered for an aperiodic transmission.

16. The method of claim 8, further comprising setting CPU occupation equal to a number of periodic resource sets plus a number of activated semi-persistent resource sets plus a number of triggered aperiodic resource sets.

17. A network node comprising:
a processor; and
a memory storing instructions that, when executed by the processor, configure the network node to:
configure a first CSI resource setting and at least a second CSI resource setting for channel measurement, wherein the first CSI resource setting and the second CSI resource setting link to one CSI reporting setting wherein the second CSI resource setting comprises different spatial relation information or a different antenna port than the first resource setting;
transmit the first CSI resource setting, the second CSI resource setting, and the CSI reporting setting to a user equipment (UE);
transmit a first CSI-RS resource using the first resource setting and a second CSI-RS resource using the second resource setting; and
receive, from the UE, a CSI-RS report comprising CSI measurements for the first CSI-RS resource and the second CSI-RS resource.

18. The computing network node of claim 17, wherein the first CSI resource setting and the second CSI-Resource setting are configured with different time domain behaviors.

19. The computing network node of claim 17, wherein when the CSI reporting setting is periodic, both the first CSI resource setting and the second CSI resource setting are periodic.

20. The computing network node of claim 17, wherein the instructions further configure the network node to transmit a Medium Access Control (MAC) control element (CE) to the UE comprising an indication of whether one or both of the first CSI-Resource configuration IE and the second CSI-Resource configuration IE are activated.
